(19) United States
(12) Patent Application Publication
(10) Pub. No.: US 2018/0327045 A1
(43) Pub. Date: Nov. 15, 2018

(54) BICYCLE FRAME COMPRISING A SINGLE UPPER BAR AND A SINGLE LOWER BAR

(71) Applicant: DECATHLON, Villeneuve d'Ascq (FR)

(72) Inventors: Clément Dauchy, Herlincourt (FR); Yue He, Lille (FR); Sylvain Venant, Louvil (FR); Guillaume Lenclen, Marcq en Baroeul (FR); Jean-Marc Guegueniat, Le Bourget (FR); Patrick Doby, Attiches (FR); Antoine Giboire, Dourges (FR); Maxime Danel, Marcq en Baroeul (FR)

(21) Appl. No.: 15/774,450

(22) PCT Filed: Nov. 8, 2016
(86) PCT No.: PCT/FR2016/052886

§ 371 Date: May 8, 2018

(30) Foreign Application Priority Data
Nov. 9, 2015 (FR) 1560698

(51) Int. Cl. B62K 19/24; B62K 3/04; B62K 19/36; B62K 19/32; B62K 19/34

(52) U.S. Cl. CPC B62K 19/24; B62K 3/04; B62K 19/34; B62K 19/32; B62K 19/36

(57) ABSTRACT

A bicycle frame comprising a saddle tube (1) connected to a single upper bar (3) and a single lower bar (4), said bars each having a front end carrying a head tube (2), said frame further comprising a strut (5) and a base (6) each having a rear end that carries a means (7) of association to respectively one side of a rear wheel of said bicycle, said strut—respectively said base—being formed in a single tube (8, 9) with the upper bar (3)—respectively lower (4) bar—, said upper (8) and lower (9) tubes being associated respectively with one side of the saddle tube (1) by extending continuously on either side of said saddle tube.

### BACKGROUND OF THE INVENTION

The invention relates to a bicycle frame as well as to a bicycle comprising such a frame.

A bicycle frame is generally formed by the association of different tubes according to a geometry allowing for the mounting in particular of wheels, of a drive system, of a saddle and of a steering unit.

In particular, the frame is formed by respective disposition and association of the various tubes in order to obtain the desired geometry, said associations being in particular carried out by welding, brazing or gluing.

According to an embodiment, the frame comprises a saddle tube on either side of which extend a front structure comprising a steering tube carrying the front gear and a rear structure for mounting the rear wheel by connecting it to the drive system.

Conventionally, the front structure has an upper bar and a lower bar connecting the saddle and steering tubes according to a geometry, for example substantially triangular, which is arranged in order to confer to the frame the expected rigidity.

Moreover, the rear structure comprises two lateral risers each formed of a strut and from a base which are connected as a rear end bearing a means for associating the wheel, said risers being positioned respectively on one side of said wheel in order to provide for the association thereof in driving.

However, due to the number of tubes used, such frame structures have a substantial weight. Furthermore, the multitude of tubes to be assembled generates a long manufacturing time as well as an increased risk of geometrical dispersion in the frames obtained.

In order to reduce the number of tubes, document DE-10 2007 038 109 proposes a bicycle frame comprising a single upper bar and a single lower bar at the rear of which extend in a single curved tube respectively a strut and a base which are arranged on either side of the rear wheel of the bicycle.

However, such a solution does not provide full satisfaction in that the carrying out of the frame remains complex, in particular concerning the mounting of the curved tubes on the steering tube and on the saddle tube, requiring several steps in particular of drilling, assembling and fastening between said tubes.

In particular, this embodiment proposes steering and saddle tubes that extend through passages formed in the curved tubes in order to form the respectively front and rear structures of the frame.

The invention aims to improve prior art by proposing in particular a bicycle frame having a reduced number of tubes and of which the manufacture and the assembly are simplified, and this while still guaranteeing the rigidity and the geometry desired for said frame.

### SUMMARY OF THE INVENTION

For this purpose, according to a first aspect, the invention proposes a bicycle frame comprising a saddle tube connected to a single upper bar and a single lower bar, said bars each having a front end carrying a head tube, said frame further comprising a strut and a base each having a rear end that carries a means of association at respectively one side of a rear wheel of said bicycle, said strut—respectively said base—being formed from a single tube with the upper bar—respectively lower bar—, said upper and lower tubes being associated respectively to one side of the saddle tube by extending continuously on either side of said saddle tube.

According to a second aspect, the invention proposes a bicycle comprising such a frame in the head tube of which a fork provided with a handlebar and with a front wheel is mounted, said bicycle comprising a saddle mounted on the saddle tube and a pedal mounted under said saddle tube, a rear wheel being mounted between the strut and the base by being associated to respectively a means of association.

### BRIEF DESCRIPTION OF THE DRAWINGS

Other particularities and advantages of the invention shall appear in the following description, given in reference to the annexed figures, wherein:

FIGS. 1 to 4 diagrammatically show a bicycle frame according to an embodiment of the invention, respectively as a perspective view of the front (FIG. 1), side (FIG. 2), as a perspective top view (FIG. 3) and top view (FIG. 4).

### DETAILED DESCRIPTION

In relation with these figures, a bicycle frame is described hereinbelow, for example for bicycles of the mountain or hybrid type, formed by the association of various tubes allowing for the mounting of the various parts of the bicycle, in particular wheels, a drive system, a saddle and a steering unit.

The frame comprises a saddle tube 1 which is mounted substantially vertically and is intended to receive a mounting rod of the saddle, said rod being associated to said saddle tube preferentially in an adjustable manner in order to allow for the adjusting of the height of said saddle.

The frame also has a head tube 2 intended for the mounting of the front gear of the bicycle and which is arranged in front of the saddle tube 1, said saddle tube and said tube defining a sagittal plane P of the bicycle frame.

The head tube 2 is arranged to receive a fork for fastening the front wheel which is mounted in said tube for example on ball bearings that form the headset. The upper end of the fork can be provided with a stem for associating a handlebar of the bicycle that extends above the head tube 2.

In particular, the frame comprises a single upper bar 3 and a single lower bar 4 which are connected to the saddle tube 1 by each one having a front end carrying the head tube 2, said bars extending between said saddle tube and said tube according to a geometry defining the size of said frame.

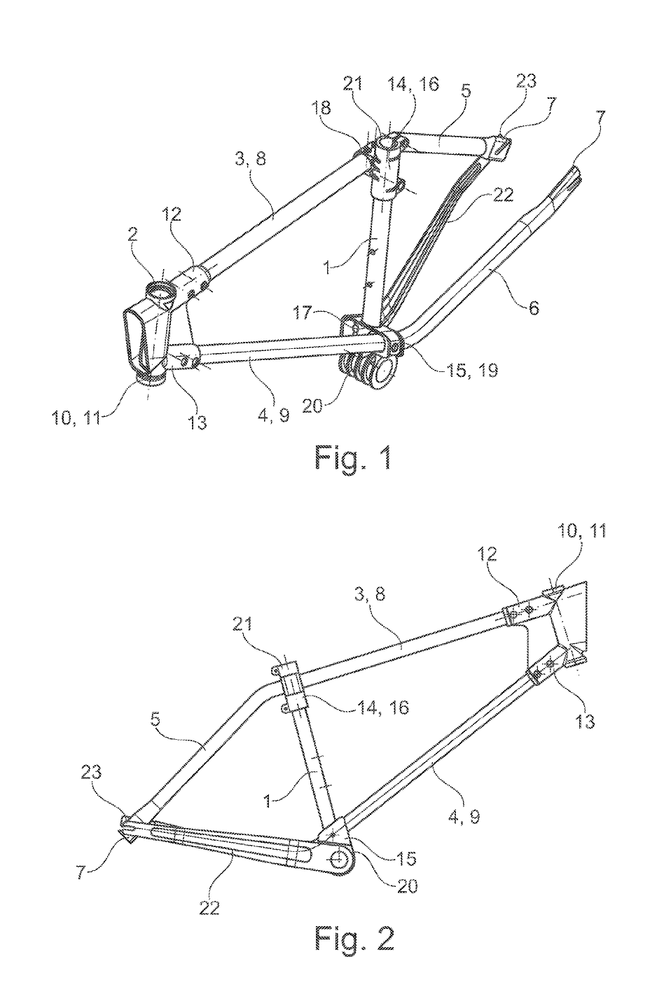

In relation with FIGS. 1 and 2, the upper 3 and lower 4 bars extend between the head tube 2 and the saddle tube 1 in a respectively substantially horizontal and oblique manner, forming a front frame structure with a substantially triangular geometry in order to allow for a sufficient frame rigidity. Alternatively, the upper bar 3 can be more or less inclined towards the rear in order to confer to the frame the expected rigidity.

Furthermore, the frame comprises a lateral strut 5 and a base 6 which are intended for the mounting of the rear wheel of the bicycle by connecting it to the drive system, in particular to the chain components of said system.

So as to limit the number of tubes of the frame its manufacturing time, a single strut 5 and a single base 6 are provided for the mounting of the rear wheel, said strut and said base extending on either side of said wheel in order to ensure the association thereof in driving.

In particular, the strut 5 and the base 6 extend respectively in an oblique manner from the upper end of the saddle tube 1 and substantially horizontally from the lower end of said saddle tube, by each having a means of association allowing for the mounting of the rear wheel between said strut and said base.

In relation with FIG. 1, the strut 5 and the base 6 each have a rear end carrying a means of association to respectively one side of the rear wheel. Each means of association can include for example a fastening bracket 7 which is provided with a rear opening of the mounting of an axis of the rear wheel, said bracket being added or formed as a single piece with respectively the strut 5 and the base 6.

The strut 5 and the base 6 are formed as a single piece with the respectively upper 3 and lower 4 bars. The frame as such has two main respectively upper 8 and lower 9 tubes which are connected to the saddle tube 1 by extending between the head tube 2 and respectively a side of the rear wheel, forming respectively an upper bar 3/strut 5 unit and a lower bar 4/base 6 unit.

In particular, the upper 8 and lower 9 tubes are each curved by having an elbow portion on either side of which extend the strut 5—respectively the base 6—and the upper bar 3—respectively lower bar 4.

In relation with the figures, the shape of the various tubes 1, 8, 9 and of the tube 2 of the frame is cylindrical, with the strut 5 and the base 6 having a tapered rear end bearing fastening bracket 7 to the rear wheel which is flat. The tubes 1, 8, 9 can be carried out using steel in order to favour rigidity and the resistance of the frame or using aluminium or a composite material, in particular with a carbon fibre base, in order to optimise the weight of said frame.

The upper 8 and lower 9 tubes are respectively associated to a side of the saddle tube 1 by extending continuously on either side of said saddle tube. As such, the frame is formed without the need for an operation of drilling and/or of cutting the tubes 1, 8, 9, simplifying the assembly of said frame and favouring the reliability in carrying out of the geometry thereof.

To do this, it is provided to arrange the front ends of the bars 3, 4 by spacing them vertically and by offsetting them angularly in relation to the sagittal plane P according to a respective angle α₁, α₂ which is arranged so that each one of the bars 3, 4 extends in a respective plane P₁, P₂ from the head tube 2 to the saddle tube 1.

In the embodiment shown, the angles α₁, α₂ between the bars 3, 4 and the plane P are substantially of the same value, with planes P₁ and P₂ forming a reduced angle with the vertical. Alternatively, a different angular shift can be provided between each one of the bars 3, 4 and the plane P.

In particular, the upper 8 and lower 9 tubes are associated to the saddle tube 1 and carry the head tube 2 by the intermediary of connectors arranged in order to connect said tubes and said tube according to inclinations and predefined angles, guaranteeing the desired geometry of the frame.

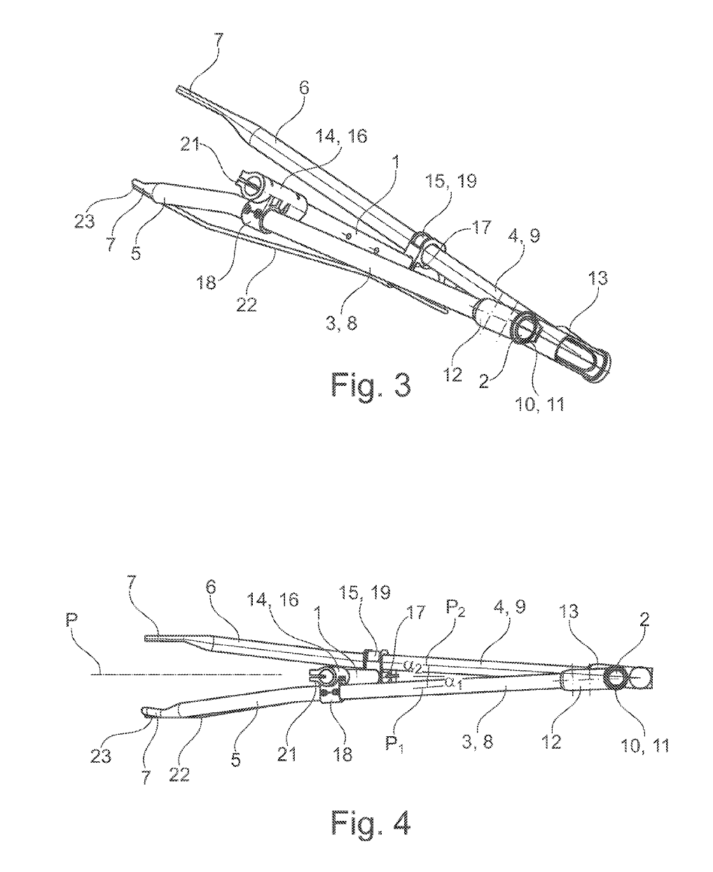

The frame comprises a front connector 10 having a vertical sleeve 11 wherein the head tube 2 is arranged and two rear sleeves 12, 13 in each one of which the front end of a bar 3, 4 is associated. In relation with FIGS. 3 and 4, the rear sleeves 12, 13 extend from the vertical sleeve 11 by being angularly offset, in particular by an angle equal to respectively α₁ and α₂ on either side of the plane P in order to make it possible to arrange the bars 3, 4 in their respective plane P₁, P₂.

Furthermore, the saddle tube 1 is associated with the upper 8 and lower 9 tubes by the intermediary respectively of an upper connector 14 and of a lower connector 15, said connectors each having means for associating a tube 8, 9 which are arranged on either side of said saddle tube.

According to the embodiment shown, the upper 14 and lower 15 connectors each have a vertical sleeve 16, 17 for mounting around the respectively upper and lower end of the saddle tube 1 and a lateral sleeve 18, 19 wherein the respectively upper 8 and lower 9 tube is associated.

In particular, the lateral sleeves 18, 19 extend horizontally on a left or right side of the vertical sleeve 16, 17, by being associated with the respectively upper 3 and lower 4 bars, more precisely before the elbowed portions of the respectively upper 8 and lower 9 tubes.

Advantageously, the tubes 8, 9 can be arranged so that the strut 5 and the base 6 extend substantially in the plane P₁, P₂ of the respective bars 3, 4. Alternatively, it can be provided to form the upper tube 8 and/or the lower tube 9 with respectively a strut 5 and a base 6 that extend outwards or inwards in relation to the respective plane P₁, P₂, according to the needs for the mounting of the rear wheel.

In particular, the strut 5 and the base 6 can extend on the side of the saddle tube 1 whereon respectively the upper tube 8 and the lower tube 9 are associated, as such avoiding crossing of said strut and base behind the saddle tube 1 in order to allow for the association of the rear wheel. In the figures, the base 6 extends from the left side of the saddle tube 1, from said tube to the fastening bracket 7, as such facilitating the integration of the right side of the drive system of the bicycle.

The connectors 10, 14, 15 can each be made from a single piece, for example from a plastic material, the various sleeves 11, 12, 13, 16, 17, 18, 19 having a cylindrical shape that is complementary with those of the tubes 1, 8, 9 and with the head tube 2. The various tubes 1, 8, 9 and the tube 2 can be associated with the corresponding sleeves 11, 12, 13, 16, 17, 18, 19 without a need for welding or gluing in order to optimise costs and the manufacturing time of the frame.

Furthermore, a reversible association can be provided of the tubes 1, 8, 9 to the connectors 10, 14, 15, allowing for quick and easy mounting and dismounting of the frame by the user, in particular in the case of a bicycle that has the form of a kit. In particular, the connectors 10, 14, 15 are arranged to allow for the assembly of the tubes 1, 8, 9 and of the tube 2 according to the predefined geometry for the frame, and this without a risk of dispersion in the relative disposition of said tubes.

According to the embodiment shown, the upper 8 and lower 9 tubes are mounted in the rear sleeves 12, 13 and lateral sleeves 18, 19 by press fitting then fastened in position by screwing. In particular, the press fitting of the tubes 8, 9 can be carried out by rotation and translation of said tubes in the corresponding sleeves 12, 13, 18, 19, the screwing being carried out by means of screws passing though said sleeves and said tubes.

Moreover, the connectors 10, 14, 15 can be provided with means for associating other parts and accessories of the bicycle, such as the saddle, brake cables or headlights. The lower connector 15 can as such be provided with means for mounting a pedal of the drive system and/or the upper connector 14 can be provided with means for mounting the saddle rod of said bicycle.

In relation with the figures, the lower connector 15 has a case 20 for mounting the pedal that extends under the vertical 17 and lateral 19 sleeves. The upper connector 14 is provided with a tightening collar 21 that allows for the adjustable mounting of the saddle rod in order to adjust the height of said rod to the size of the user and/or to the desired exercise position, said collar being formed in the upper continuity of the vertical sleeve 16 of said connector.

In order to optimise the rigidity of the frame, a second base 22 can be provided which extends on the side of the rear wheel that is opposite that in which extends the first base 6, said second base extending from the saddle tube 1 to the rear end of the strut 5.

According to the embodiment shown, the second base 22 is added between the saddle tube 1 and the rear end of the strut 5, by having a front end that is associated to said saddle tube on the same side as the upper tube 8 and a rear end adjacent to that of said strut.

In particular, the rear end of the second base 22 carries a means of association with the rear wheel which is complementary to that of the strut 5. In relation with FIG. 2, the means of association of the second base 22 is a fastening bracket 23 having a rear opening that is superimposed on that of the fastening bracket 7 of the strut 5.

This embodiment makes it possible in particular to facilitate the mounting of the drive chain between the pedal and the rear wheel, in that the brackets 7, 23 can be separated in order to allow for arranging the chain around the second base 22 in order to be connected to said wheel, and this without opening said chain. Then, tightening of the rear wheel between on the one hand the brackets 7, 23 and, on the other hand the left bracket 7, induces a coupling of the brackets 7, 23 in order to ensure the association of said wheel between the base 6 and the strut 5.

The front end of the second base 22 is associated to the lower connector 15, in such a way as to work as torsion between the pedal case 20 and the bracket 7 of the strut 5, making it possible to reinforce the rigidity of the frame, in particular for avoiding the twisting of the rear wheel.

1. A bicycle frame comprising:
a saddle tube connected to a single upper bar and a single lower bar, said bars each having a front end carrying a head tube, said frame further comprising a strut and a base each having a rear end that carries a means of association to respectively a side of a rear wheel of said bicycle,
said strut and respectively said base being formed in a single tube with the upper bar and respectively lower bar,
wherein said frame comprises the upper tube and lower tube are associated respectively to a side of the saddle tube by extending continuously on either side of said saddle tube.

2. The bicycle frame according to claim 1, wherein the front ends of the upper bar and lower bar are spaced vertically and are angularly offset in relation to a sagittal plane by a respective angle which is arranged so that each one of said vertical bars extends in a respective plane from the head tube to the saddle tube.

3. The bicycle frame according to claim 2, wherein the bicycle frame comprises a front connector wherein the head tube is arranged, said front connector having two sleeves in each one of which the front end of bar is associated.

4. The bicycle frame according to claim 3, wherein the sleeves are angularly offset.

5. The bicycle frame according to claim 4, wherein the strut extends in the plane of the upper bar and/or the base extends in the plane of the lower bar.

6. The bicycle frame according to claim 5, wherein the strut and the base extend on the side of the saddle tube whereon respectively the upper tube and the lower tube are associated.

7. The bicycle frame according to claim 6, wherein the base extends on the left side of the saddle tube.

8. The bicycle frame according to claim 7, wherein the upper bar extends substantially horizontally, the lower bar being oblique.

9. The bicycle frame according to claim 8, wherein the saddle tube is provided with an upper connector and with a lower connector each having a means of association of a tube, said means being arranged on either side of said saddle tube.

10. The bicycle frame according to claim 9, wherein each connector has a vertical sleeve for mounting around the saddle tube and a lateral sleeve wherein the tube is associated.

11. The bicycle frame according to claim 10, wherein the lower connector is provided with means for mounting the pedal of the bicycle and/or the upper connector is provided with means for mounting the saddle rod of said bicycle.

12. The bicycle frame according to claim 11, wherein the frame comprises a second base extending from the saddle tube to the rear end of the strut.

13. The bicycle frame according to claim 12, wherein the second base has a rear end carrying a means of association of the rear wheel which is complementary with that of the strut.

14. The bicycle frame according to claim 13, wherein the second base has a front end which is associated to the saddle tube of the same side as the upper tube.

15. A bicycle comprising a frame according to claim 14, wherein, in the head tube of which a fork provided with a handlebar and with a front wheel is mounted, said bicycle comprising a saddle mounted on the saddle tube and a pedal mounted under said saddle tube, a rear wheel being mounted between the strut and the base by being associated to respectively a means of association.
